(19) United States
(12) Patent Application Publication
(10) Pub. No.: US 2005/0111073 A1
(43) Pub. Date: May 26, 2005

(54) Integrated variable optical attenuator and related components

(75) Inventors: Jing-Jong Pan, Milpitas, CA (US); Xiangong Qiu, Cupertino, CA (US); Feng Qing Zhou, San Jose, CA (US); Henry Hongying He, San Jose, CA (US); Changhong Jiang, Fremont, CA (US); Hai-Ming Wu, Milpitas, CA (US)

Correspondence Address: RITTER, LANG & KAPLAN, 12930 SARATOGA AE. SUITE D1, SARATOGA, CA, 95070, US

(73) Assignee: LIGHTWAVES 2020, INC., Corporation of California, MILPITAS, CA (US)

(21) Appl. No.: 10/718,030

(22) Filed: Nov. 20, 2003

(51) Int. Cl. H04B 10/00; G02F 1/09

(52) U.S. Cl. 359/280

(57) ABSTRACT

A polarization element and a polarization-sensitive optical isolator are integrated to form an integrated VOA. A preferred embodiment uses a liquid crystal cell as the polarization element to which is attached an optical isolator core of a first polarizer, Faraday rotator, and second polarizer. Voltage on the liquid crystal cell electrodes controls the amount of polarized light from the liquid crystal cell passing through the first polarizer and light in the opposite direction is blocked. The integrated VOA can be mounted within a laser device package so that the power of the source laser diode on the output fiber can be controlled and yet the laser diode is protected from light undesirably entering laser device package through the output fiber.

### BACKGROUND OF THE INVENTION

The present invention is related to optical devices for fiberoptic systems and networks and, in particular, to variable optical attenuators.

In current fiberoptic systems and networks, variable optical attenuators (VOAs) are ubiquitous. VOAs are typically used for adjusting the strength of signals so that signals are balanced across the network wavelength transmission range. Signal strength variation arises from variations in the performance of lasers which generate the optical signals, or of other network components through which the signals pass. Without such adjustments, signal distortion, crosstalk and other deleterious effects can occur.

There are many different devices in fiberoptic systems and networks, including VOAs, and in any system it would seem beneficial to combine such elements to reduce the complexity of the system and the costs of manufacture and installation. However, combination is not simply a matter of placing two or more previously separate devices in one package. Element combination does have disadvantages, such as a resulting lack of flexibility in system design and cost savings which are illusory.

The present invention is based on an analysis of fiberoptic systems and recurrent network combinations of devices, and a further analysis of the peculiarities of device construction and performance. Accordingly, the present invention provides for an integrated VOA which not only reduces complexity and costs, but is miniaturized with the additional benefits of increased ease of installation and better reliability. Miniaturization also provides for further integration into laser devices, which generate the light signals for fiberoptic networks, among other applications.

### SUMMARY OF THE INVENTION

The present invention provides for an integrated variable optical attenuator which has a polarization element which continuously varies the state of polarization of polarized light incoming to the integrated variable optical attenuator responsive to a control signal. The integrated variable optical attenuator also has a polarization-sensitive optical isolator fixed with respect to said polarization element so that the amount of polarized light from said polarization element and passing through the polarization-sensitive optical isolator is varied by the state of polarization responsive to the control signal. This combination of polarization element and optical isolator permits integration for a miniaturized device.

The present invention also provides for an integrated variable optical attenuator which has a liquid crystal cell having first and second plates, and an optical isolator core, a first polarizer, a Faraday rotator, and a second polarizer, is fixed to the liquid crystal cell to form an integrated assembly. Each liquid crystal cell plate has an electrode coating thereon and the liquid crystal cell rotates polarized light responsive to the amount of voltage applied between the electrodes. The amount of polarized light from the liquid crystal cell and passing through the optical isolator core is varied by the amount of voltage applied between the electrodes of the liquid crystal cell. The first polarizer comprises a linear polarizer with a first transmission axis, and the second polarizer comprises a linear polarizer with a second transmission axis aligned at 45° from the first transmission axis.

The present invention also provides for an integrated laser diode assembly having a laser diode which emits polarized light, a first lens proximate the laser diode arranged and oriented to collimate the polarized light from the laser diode; and an integrated variable optical attenuator proximate the first lens opposite the laser diode and arranged to receive the collimated light from the first lens, a second lens arranged and oriented to focus light from the integrated variable optical attenuator, and a section of output optical fiber having an end arranged and oriented with respect to the second lens so that light from the second lens is focused at the end of the output optical fiber section. In one embodiment of the integrated laser diode assembly, the integrated variable optical attenuator has a liquid crystal cell and optical isolator core in an assembly so the amount of polarized light from the laser diode passing through the liquid crystal cell and the optical isolator core is controlled by the amount of voltage applied between electrodes of the liquid crystal cell. In the other direction, light from second lens is blocked.

### BRIEF DESCRIPTION OF THE DRAWINGS

FIG. 1A is a diagram of a representative fiberoptic network which illustrates the function of variable optical attenuators in such networks; FIG. 1B is a diagram of a typical arrangement of a laser diode and variable optical attenuator in the FIG. 1A network;

FIG. 2 is a representational diagram of an integrated VOA, according to one embodiment of the present invention;

FIG. 3 is a representational diagram of a polarization-sensitive optical isolator suitable for the integrated VOA of FIG. 2;

FIG. 4A is a cross-sectional diagram of the liquid crystal cell of the integrated VOA of FIG. 2; FIG. 4B is a cross-sectional diagram of the combination of the liquid crystal cell and the optical isolator core of the integrated VOA of FIG. 2; FIG. 4C is a three-dimensional view of the integrated VOA of FIG. 4B;

FIG. 5A is a cross-sectional diagram of a laser device with an integrated VOA, according to an embodiment of the present invention; FIG. 5B is a cross-sectional diagram of another laser device with an integrated VOA, according to another embodiment of the present invention; FIG. 5C is an electrical schematic of the laser devices of FIGS. 5A and 5B; and

FIG. 6 is a cross-sectional diagram of a laser device with the semiconductor laser diode left in its TO package, according to still another embodiment of the present invention.

### DESCRIPTION OF SPECIFIC EMBODIMENTS

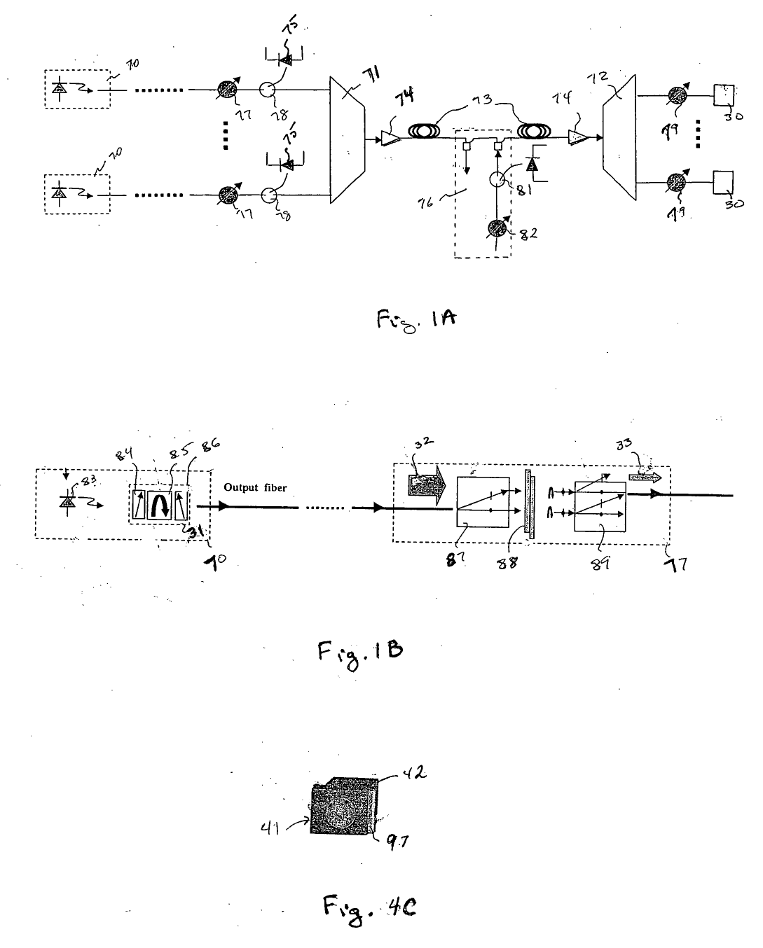

FIG. 1A is an exemplary optical network by which optical signals from transmitting users are sent through an optical fiber to multiple receiving users. In this representative fiberoptic network, lasers 70 generate optical signals for the transmitting users. The signal strength from each laser 70 is controlled by a VOA 77 responsive to power-monitor readings from a photodiode 75 which is connected to a tap coupler 78 diverting a small fraction of the signal from the output terminal of the VOA 77 to the photodiode 75. The coupler 78 passes most of the VOA output to an input terminal of a multiplexer 71 and the VOAs 77 are adjusted to balance the power of the light signals from the different lasers 70 to the multiplexer 71.

The output terminal of the multiplexer 71 is connected to an EDFA (Erbium-Doped Fiber Amplifier) 74, or other optical amplifier, which boosts the power of the signals combined by the multiplexer 71 for transmission on an optical fiber 73 to the receiving users. It should be noted that the amplification of EDFAs is not flat, but varies over wavelength, especially at the edges of the C (Conventional)-band of WDM networks. To compensate for any signal losses along the optical fiber 73, which may be quite long, the optical signals are boosted again by a second EDFA 74 at the end of the fiber 73 before being received and separated by a demultiplexer 72. At each output terminal of the demultiplexer 72, a VOA 79 controls the strength of the signal to a receiver 30.

For purposes of illustration, a node 76 (illustrated only partially) is shown connected to the optical fiber 73 by which optical signals may be added or dropped from the fiber 73. At the add/drop node 76, optical signals may be diverted, i.e., “dropped,” from the optical fiber 73 so that one or more network users not connected the demultiplexer 72 may receive signals, or optical signals may be inserted or “added,” into the optical fiber 73, so that one or more network users not connected to the multiplexer 71 may transmit signals. As in the case for the lasers 70, the add/drop node 76 has a laser (not shown) with a VOA 82 and a power-monitoring photodiode 81. A VOA and receiver corresponding the VOA 79 and receiver 30 is not shown.

FIG. 1B shows the organization of the laser 70 and VOA 77 in greater detail. The laser 70, a network component device, has a laser diode 83, a semiconductor device, which emits output light on the output optical fiber. To protect the laser diode 83 from undesirable incoming light on the output fiber, an optical isolator core is typically included in the laser 70. The optical isolator core allows light to pass in only one direction, in this case, from the laser diode 83 to the output fiber and blocks light in the opposite direction. There are many different designs of optical isolator cores; one design has a core 31 formed by a first linear polarizer 84, a Faraday rotator 85 and a second linear polarizer 86, such as shown in FIG. 1B. The transmission axes of the first and second linear polarizers 84 and 86 are aligned to form a 45° angle with each other and the Faraday rotator 85 is designed so that the polarized light from the polarizer 84 (and laser diode 83) is rotated 45° to be aligned with the transmission axis of the second polarizer 86. On the other hand, polarized light in the reverse direction from second polarizer 86 (and the output fiber) is rotated 45° so that the polarized light is aligned at 90° to the transmission axis of the first polarizer 84. Light is effectively blocked in the reverse direction.

VOAs may be different construction. In FIG. 1B, the VOA 77 is shown as being formed with two birefringent plates 87 and 89 separated by a liquid crystal cell 88. U.S. Pat. No. 5,276,747, which issued Jan. 4, 1994 to J. J. Pan, explains the details of construction for this type of VOA and its operation in detail. The voltage across the electrodes of the liquid crystal cell affects the orientation of the liquid crystal material in the cell and the amount of attenuation of the light passing through the VOA. Large arrow 32 shows symbolically the strength and direction of the laser light entering the VOA 77 and small arrow 33 shows the strength and direction of the attenuated laser light leaving the VOA.

From the representative network of FIGS. 1A and 1B, it is evident that an optical isolation function with a variable attenuation function is often found in fiberoptic networks. The present invention provides for a merging of such functions in a single, low-cost, and highly compact device. The components of the optical isolator and attenuator are selected and incorporated for the purposes of integration, optical performance and miniaturization. Among other advantages, device count in the system is reduced and total manufacturing costs are lower in comparison to those for separate devices. Furthermore, the integrated VOA can be further integrated into laser devices, as described later.

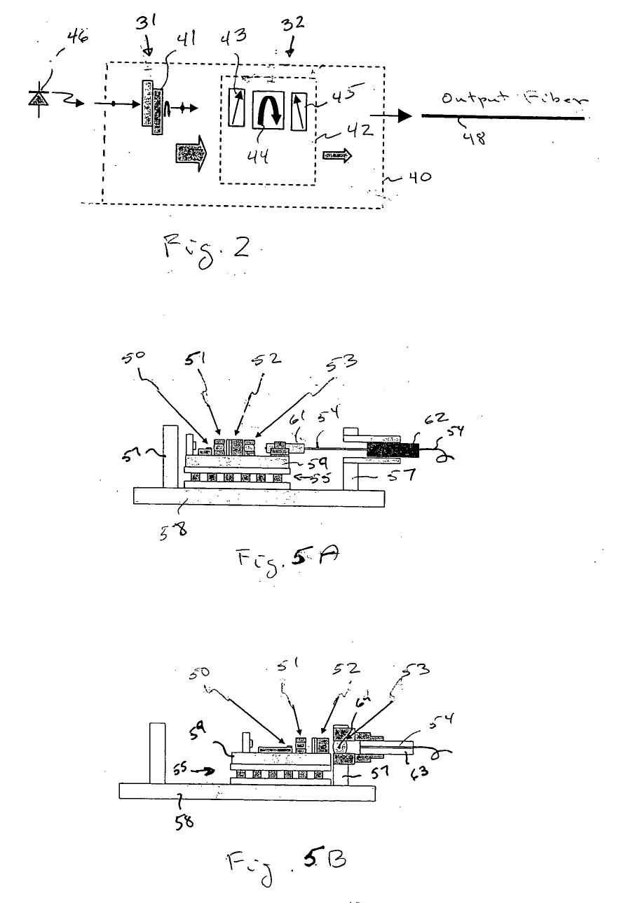

FIG. 2 illustrates the general organization of a laser device useful as a light source for fiberoptic networks with an integrated VOA, according to a preferred embodiment of the present invention. In the FIG. 2 laser device, a laser diode 46 emits light for an output fiber 48. Between the laser diode 46 and the output fiber 48 is an integrated VOA 40 which has a polarization element 31 and a polarization-sensitive optical isolator 32. The polarization element 31 can change the state of polarization of incident polarized light continuously responsive to a control signal. The amount of polarized light which passes through the polarization-sensitive optical isolator 32 varies dependent upon the state of polarization of the light from the polarization element 31. This combination of polarization element and optical isolator is integrated into a miniaturized device.

Different devices which can controllably change the state of polarization of polarized light in response to a control signal may be used for the polarization element 31. For example, a PLZT (Polycrystalline Lanthanum-modified lead Zirconate Titanate) phase retarder changes the polarization state of light passing through the retarder responsive to a voltage across the retarder plate, or a low saturation field, garnet Faraday rotator also controllably changes the state of polarization in response to the strength of a magnetic field through the rotator. The strength of the magnetic field is related to the amount of electric current passing through wire coils around the rotator. There are other devices which can be used for the polarization element 31, including those where temperature affects the amount of polarization change by the device.

Likewise, many devices may be used for the polarization-sensitive optical isolator 32. FIG. 3 shows the core assembly of an optical isolator which is suitable. The optical isolator core has a linear polarizer 21, a half-wave plate 22, a Faraday rotator 23, and an analyzer 24 (a second liner polarizer); light beams in the forward (i.e., from the polarization element 31) and backward directions are shown as being separated, for purposes of illustration. “Vertical” and “horizontal” directions as used here are two arbitrary orthogonal directions. In the forward direction, the vertical linear polarization component of an incident light beam passes through (the horizontal polarization component is blocked) the first linear polarizer 21. The light beam then encounters the half wave plate 22. Since the half wave plate 22 has its slow axis oriented 22.5° (counterclockwise) to the vertical axis, the polarization of the incident light beam is rotated 45° to the vertical axis counterclockwise after passing through the waveplate 22. The light beam's polarization returns to vertical again after passing through the 45° degree Faraday rotator 23 (which rotates clockwise). Thus the vertical component of the light beam passes through the second linear polarizer 24 without loss. In the backward direction, on the other hand, light of any polarization is blocked completely. As an example, a vertically polarized light beam which passes through the second linear polarizer 24 (horizontal polarization is blocked by the second linear polarizer 14) is rotated by the Faraday rotator 23 to the 45° orientation (clockwise if looking towards the light beam). When the light beam with this polarization encounters the half waveplate 22, the half waveplate rotates the beam's polarization 135° counterclockwise (actually the half waveplate 22 mirrors the polarization of the light beam around its slow axis) when you look towards the light beam. Thus after passing through the half waveplate 22, the light beam becomes horizontally polarized and is blocked by the first linear polarizer 21.

Other types of polarization-sensitive optical isolators are described in U.S. Pat. Nos. 5,757,538 and 5,726,801. U.S. Pat. No. 5,757,538 describes an optical core assembly with two linear polarizers, polarization gratings which are oriented at 45° to each other, on either side of a Faraday rotator. U.S. Pat. No. 5,757,538 describes an reduced optical isolator assembly with only two elements for a linearly polarized light source. The first element may be a birefringent crystal or a linear polarizer; the second element is a quarter wave plate. Further details of the construction and performance of these optical isolators may be found by perusing these patents.

But for the optimum balance of high performance, low costs and ease of integration, it is believed that a liquid crystal cell and an optical isolator core as described below serve best as a polarization element and polarization-sensitive optical isolator. As shown in FIG. 2, the liquid crystal cell 41 and the optical isolator core 42 are separated for purposes of explanation; in fact, they are an integrated assembly with the functions of isolating the laser diode 46 from undesired light from the output fiber 48 and of controlling the amount of light from the laser diode 46 to the output fiber 48.

The liquid crystal cell 41 rotates incident polarized light; the amount of rotation corresponding to the amount of control voltage applied to the liquid crystal cell 41. The laser diode 46 emits linearly polarized light and after passing through the liquid crystal cell 41, the laser light reaches the optical isolator core 42. The core 42 has a linear polarizer 43, a Faraday rotator 44, and a second linear polarizer 45. The transmission axis of the second polarizer 45 is arranged at 45° to the transmission axis of the first polarizer 43 and the Faraday rotator 44 is designed so that polarized light traveling from the first polarizer 43 to the second polarizer 45 is rotated 45° and the polarized light is aligned with the transmission axis of the second polarizer 45. Light traveling from the second polarizer 45 to the first polarizer 43 is rotated 45° by the Faraday rotator so that the polarized light is aligned 90° to the transmission axis of the first polarizer 43 so that the light is blocked. Hence the liquid crystal cell 41 works with the optical isolator core 42 to function as a VOA in one direction, the optical isolator core 42 functions as an optical isolator in the other direction.

The transmission axis of the first polarizer 43 is arranged and oriented with respect to the liquid crystal cell 41 to permit a variable attenuation in response to the amount of voltage impressed upon the cell 41. For example, if there is no rotation of polarized light passing through the cell 41 with no applied voltage, then the transmission axis of the polarizer 43 can be aligned with the linear polarized light emitted from the laser diode 46. With zero applied voltage to the cell 41, a maximum amount of light is transmitted through the polarizer 43 and the isolator core 42 to the output fiber 48. When a voltage is impressed upon the cell 41 so that the polarized light from the laser diode 46 is rotated 90°, then the polarized light from the laser diode 46 is effectively blocked by the first polarizer 43. The state of polarization of the laser light is 90° to the transmission axis of the-polarizer 43.

With the same elements, the integrated VOA 40 can operate so that light is blocked at zero applied voltage and completely transmitted at a given maximum voltage. The optical isolator core 42 is rotated 90° so the transmission axis of the first polarizer 43 is perpendicular to the linearly polarized light from the laser diode 46. In a similar fashion, if the liquid crystal cell 41 rotates polarized light without any applied voltage, the optical isolator core 42 can be rotated so that a maximum (or minimum) amount of light is transmitted through the VOA. Of course, other relationships between voltage applied to the liquid crystal cell 41 and the amount of light attenuated by the device can be created.

FIG. 4A is a cross-sectional side view of the liquid crystal cell 41, the manufacture of which adopts many of the semiconductor manufacturing. The substrates 91 and 92 which form the flat, transparent plates of the liquid crystal cell are formed from glass wafers. The surfaces of the wafers which are to be the interior walls of each of the substrates or plates 91 and 92 are covered with transparent ITO (Indium Tin Oxide) coating 94, which are the voltage electrodes for the liquid crystal material 93. Over the ITO coating 94 is printed a patterned polyimide layer 95 which create the alignment electric field for the liquid crystal material 93. In a well-known technique, the polyimide layers are rubbed to induce an electrical anisotropy in the layers so the induced local electric field aligns the liquid crystal in the assembled cell. Sealant is then printed on the wafers in a pattern which defines the substrates 91 and 92 in the different glass wafers for each liquid crystal cell. The glass wafers are paired and then diced to define the substrates 91 and 92 as plates for the liquid crystal cell. Spacers 96 are placed on sealant at the edges of one of the now-defined plates 91 and 92 and liquid crystal material is poured into the space created by the spacers 96. Various liquid crystal materials may be used as the material 93, including PAN (Parallel Aligned Nematic) liquid crystal, TN (Twisted Nematic) liquid crystal, and HAN (Homeotropically Aligned Nematic) liquid crystal. The plates 91 and 92 are brought together and sealed. They are offset from each other in one direction so that the ITO coatings 94 which run to the edges of the plates 91 and 92 are exposed. Electrodes 97, rod sections of Kovar (a registered trademark of CRS Holding, a subsidiary of Carpenter Technology, Inc. of Reading Pa.) plated with gold, are bonded to the exposed ITO coatings 94 by silver epoxy 98.

The isolator core 42 is assembled separately from the liquid crystal cell 41. The polarizers 43 and 45 are linear polarizer plates of Polarcor (a trademark of Coming, Inc. of Coming, N.Y.). CUPO polarizers from Hoya Corporation USA of San Jose, Calif.; colorPol (a registered trademark of Codixx AG of Barleben, Germany) polarizers; and SubWave polarizers from NanoOpto Corp. of Somerset, N.J. may also be used. The Faraday rotator 44 is formed by impurity-doped garnet, such as YIG (Yttrium Iron Garnet), or other materials, placed in a permanent magnet. As explained previously, the transmission axis of the second polarizer 45 is arranged at 45° to the transmission axis of the first polarizer 43 . The Faraday rotator 44 is designed to rotate polarized light traveling from the first polarizer 43 to the second polarizer 45 to align the polarized light with the transmission axis of the second polarizer 45. The polarizers 43 and 45 and the Faraday rotator 44 with reciprocal shapes are mounted in a square or rectangular cylinder of Kovar or stainless steel to prevent these elements from rotating. The isolator core 42 is then bonded by epoxy to the outside wall of the second plate 92, as shown in FIG.3B. The integrated VOA 40 is assembled.

A three dimensional view of the integrated VOA 40 is illustrated in FIG. 4C. As illustrated, the liquid crystal cell 41 is attached to the optical isolator core 42. One electrode 97 of a pair belonging to the liquid crystal cell 41 is also shown in this view. The integrated device 40 is highly compact with the functions of attenuation and optical isolation. Dimensions of the device are currently 2.8 mm long and 2.6 mm wide in its widest lateral dimension. The number of elements of the integrated device is greatly reduced over the number of elements of separate optical isolator and variable attenuator devices. Assembly costs are also lowered. Performance is increased, on the other hand. Where the two separate devices typically have insertion losses greater than 0.5 dB, the integrated VOA has been found to have an insertion loss of less than 0.2 dB with lower power consumption.

The compact integrated VOA is perfectly adapted for laser devices, common sources for light signals in fiberoptic networks, and can itself be integrated into laser devices. FIGS. 5A and 5B illustrate different arrangements of laser devices with integrated VOAs. To better explain the present invention, the same references numerals are used for the identically or similarly functioning elements in both drawings and in FIG. 5C to a certain extent. Each laser device has a laser diode 50 which is mounted with electrical leads (not shown) to carry the laser diode drive current. The light emitted from the laser diode 50 is collimated by a first lens 51 and then reaches an integrated VOA 52 whose operation has been described above. The VOA output light, whose intensity is controlled by the integrated VOA 52, is focused by a second lens 53 at an end facet of an output optical fiber 54 which has its end section facing the second lens 53 held by a ferrule 61. Another section of the optical fiber 54 removed from the end section is held by another ferrule 62.

The laser diode 50, the first collimating lens 51, the integrated VOA 52, the focusing lens 53, and their mounts are fixed to a metal base 54. Likewise, the ferrule 61 for the output optical fiber 54 is also fixed to the base 59. Since the laser diode 50 generates heat in operation, a thermal electric cooler 55 is used to transfer heat away from the laser diode 50 and the base 59 to prevent overheating and to maintain the temperature at a fixed point. This allows the laser diode 50 to remain at pre selected operating conditions. The thermal electric cooler 55 has one surface attached to the base 59 and a second side attached to the package base 58 for the laser device. The end walls 57 of the laser device package are shown in the drawings. An enclosing top cover for the package is not shown, nor are side walls of the package, which is hermetically sealed at the end of the manufacturing process.

In the arrangement of the FIG. 5B laser device, the second lens 53 is mounted in a holder 64 which in turn is fixed to an end wall 57 of the device package. Also mounted in the holder 64 is a ferrule 63 which holds the output optical fiber 54. To compensate for the placement of the focusing lens 53, the base 59 (along with the laser diode 50, the first collimating lens 51, and the integrated VOA 52) is moved close to the end wall 57.

FIG. 5C is a “pin-out” diagram for the electrical connections of the laser devices of FIGS. 5A and 5B. Each of the external leads, i.e., pins, are numbered 1-14 in accordance with standard package specification practice. The leads 6 and 7 provide power for the thermal electric cooler 55, the leads 4 and 5 are connected to a photodiode 35 (not shown in FIGS. 4A and 4B) which monitors the output of the laser diode 50. Leads 3, 11, and 12 provide the power for the laser diode 50. Leads 1 and 2 are coupled to a small resistor (also not shown in FIGS. 4A and 4B) with a resistive value RT which varies according to temperature. This arrangement monitors the temperature of the laser package. Finally, leads 13 and 14 are leads for the voltage applied to the liquid crystal cell 66 of the integrated VOA 52 to control the amount of attenuation of the light emitted from the laser diode 50 to the output optical fiber 54. The optical isolator 65, part of the integrated VOA 52, has no electrical connection.

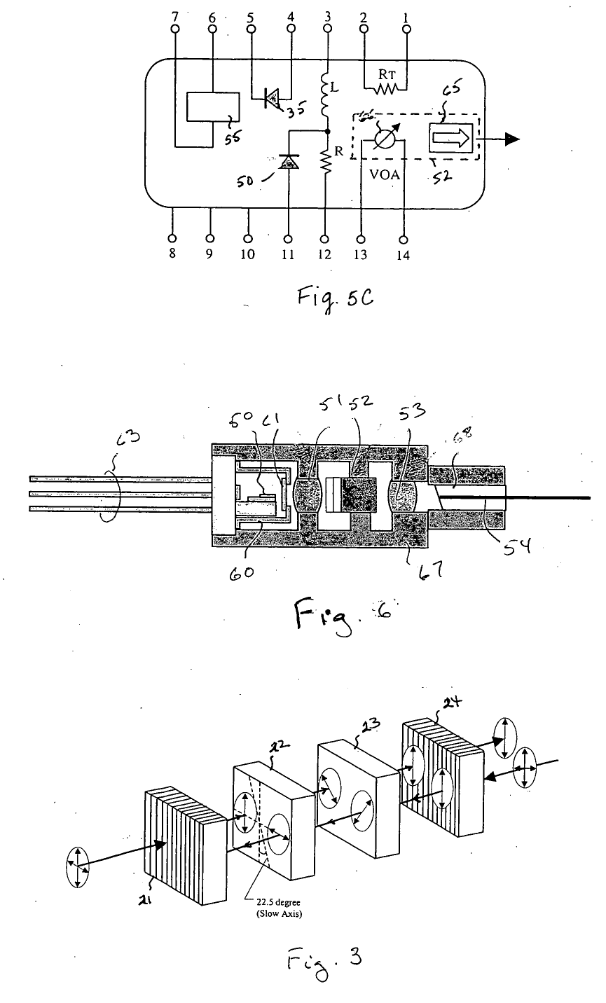

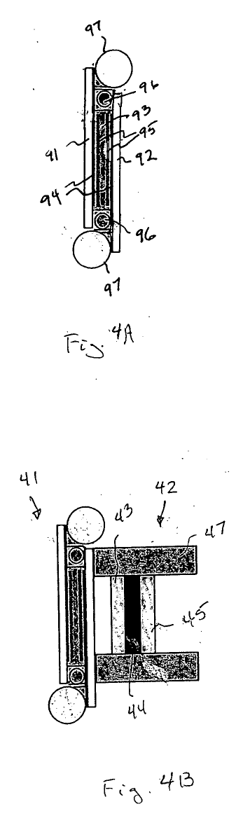

FIG. 6 is another arrangement for a laser device having an integrated VOA of the present invention. In this case, the laser diode has its own package in the form of a TO can 60 with a transparent window 61 through which the output of the laser diode passes. The TO can 60 with leads 63 to power the laser diode, has is fixed into and mounted to a housing package 67 which has a first lens 51 mounted next to the transparent window 61. The first lens 51 collimates the light from the laser diode. The collimated light passes through an integrated VOA 52 which is mounted next to the first lens 51. On the other side of the integrated VOA 52 is mounted a second lens 53 which focuses the light merging from the integrated VOA 52 upon the end of the output optical fiber 54. The optical fiber 54 is held by a ferrule 68 which is fixed to the housing package 67. A detail of the end facet of the optical fiber 54 and ferrule 68 is shown in FIG. 4. The end facet is angled slightly 6-8° from the longitudinal axes of the fiber and ferrule and is coated anti-reflection materials to reduce reflection of the light from the lens 53. This detail is also true for the end facets of the fiber 54 and ferrules 61 and 63 of FIGS. 3A and 3B respectively.

Hence where only the optical isolation function was incorporated into laser devices, the present invention now adds the variable attenuation function. Overall part count is reduced and costs are lowered, and as noted previously, optical performance is improved.

Therefore, while the description above provides a full and complete disclosure of the preferred embodiments of the present invention, various modifications, alternate constructions, and equivalents will be obvious to those with skill in the art. Thus, the scope of the present invention is limited solely by the metes and bounds of the appended claims.

1. An integrated variable optical attenuator comprising:
a polarization element for continuously varying the state of polarization of polarized light incoming to said integrated variable optical attenuator responsive to a control signal; and
a polarization-sensitive optical isolator fixed with respect to said polarization element so that the amount of light polarized light passing through said polarization element and said polarization-sensitive optical isolator can be varied by said control signal.

2. The integrated variable optical attenuator of claim 1 wherein said polarization element comprises a liquid crystal cell.

3. The integrated variable optical attenuator of claim 2 wherein said liquid crystal cell comprises a liquid crystal material selected from the group comprising PAN liquid crystal, TN liquid crystal, and HAN liquid crystal.

4. The integrated variable optical attenuator of claim 2 wherein said polarization element comprises a PLZT phase retarder.

5. The integrated variable optical attenuator of claim 2 wherein said polarization element comprises a low saturation field, garnet Faraday rotator.

6. The integrated variable optical attenuator of claim 1 wherein said polarization-sensitive optical isolator comprises a first linear polarizer proximate said polarization element, a Faraday rotator in fixed relationship to said first linear polarizer, and a second linear polarizer in fixed relationship to said Faraday rotator.

7. The integrated variable optical attenuator of claim 6 wherein said first and second linear polarizer comprise first and second polarization gratings respectively.

8. The integrated variable optical attenuator of claim 1 wherein said polarization-sensitive optical isolator comprises a first linear polarizer proximate said polarization element, a half-wave plate, a Faraday rotator and a second linear polarizer.

9. The integrated variable optical attenuator of claim 6 wherein said polarization-sensitive optical isolator comprises
a first element proximate polarization element, said first element selected from the group comprising a birefringent crystal and a linear polarizer; and
a quarter-wave plate.

10. An integrated variable optical attenuator comprising:
a liquid crystal cell having first and second plates, each having an electrode mounted thereon, said liquid crystal cell rotating polarized light responsive to the amount of voltage applied between said electrodes; and
a polarization-sensitive optical isolator core fixed to said liquid crystal cell, said optical isolator core having a first polarizer, a Faraday rotator, and a second polarizer arranged with respect to each other so that the amount of polarized light from said liquid crystal cell passing through said first polarizer is controlled by said amount of voltage applied between said liquid crystal cell electrodes, and light passing through said second polarizer and said Faraday rotator to said first polarizer is blocked.

11. The integrated variable optical attenuator of claim 10 wherein liquid crystal cell comprises material is selected from the group comprising PAN liquid crystal, TN liquid crystal, and HAN liquid crystal.

12. The integrated variable optical attenuator of claim 10 wherein said first polarizer comprises a linear polarizer having a first transmission axis, and said second polarizer comprises a linear polarizer having a second transmission axis aligned at 45° from said first transmission axis.

13. The integrated variable optical attenuator of claim 12 wherein said transmission axis is aligned with polarized light from said liquid crystal cell with no voltage applied between said electrodes.

14. The integrated variable optical attenuator of claim 12 wherein said transmission axis is aligned at 90° with polarized light from said liquid crystal cell with no voltage applied between said electrodes.

15. An integrated laser diode assembly comprising:
a laser diode;
a first lens proximate said laser diode, said first lens arranged and oriented with respect to said laser diode to collimate light from said laser diode;
an integrated variable optical attenuator proximate said first lens opposite said laser diode, said integrated variable optical attenuator arranged and oriented to receive collimated light from said first lens, said integrated variable optical attenuator further comprising:
a liquid crystal cell having first and second plates, each plate having an electrode mounted thereon, said liquid crystal cell rotating polarized light responsive to the amount of voltage applied between said electrodes, said first plate proximate and facing said first lens; and
an optical isolator core having a first polarizer fixed to said second plate of said liquid crystal cell, a Faraday rotator fixed to said first polarizer, and a second polarizer fixed to said Faraday rotator, the amount of polarized light passing through said liquid crystal cell and said optical isolator core controlled by the amount of voltage applied between said electrodes of said liquid crystal cell;
a second lens proximate said second polarizer of said optical isolator core opposite said Faraday rotator, said second lens arranged and oriented to focus light from said integrated variable optical attenuator, and
a section of output optical fiber having an end, said output optical fiber section arranged and oriented with respect to said second lens so that light from said second lens is focused at said end of said output optical fiber section.

16. The integrated laser diode assembly of claim 15 wherein output light from said laser diode is linearly polarized in a first direction and said first polarizer comprises a linear polarizer having a first transmission axis aligned along said first direction.

17. The integrated laser diode assembly of claim 16 wherein said second polarizer comprises a linear polarizer having a second transmission axis aligned at 45° with respect to said first transmission axis.

18. The integrated laser diode assembly of claim 15 further comprising:
a base, said laser diode, first lens, integrated variable optical attenuator; second lens and said end of said output optical fiber section mounted thereto; and
a package enclosing said base, said laser diode, first lens, integrated variable optical attenuator and second lens, a portion of said output optical fiber section removed from said end mounted to said package.

19. The integrated laser diode assembly of claim 15 further comprising:
a base, said laser diode, first lens, and integrated variable optical attenuator mounted thereto; and
a package enclosing said base, said laser diode, first lens, and integrated variable optical attenuator, said second lens, a portion of said output optical fiber section including said end mounted to said package.

20. The integrated laser diode assembly of claim 15 further comprising:
a package enclosing and mounting said base, laser diode, first lens, and integrated variable optical attenuator, second lens, a portion of said output optical fiber section including said end mounted to said package.

21. The integrated laser diode assembly of claim 20 wherein said laser diode is mounted in a laser diode package and said laser diode package is mounted to said package.

22. The integrated laser diode assembly of claim 21 wherein said laser diode package comprises further comprising a TO-can.
